(19) United States
(12) Patent Application Publication
(10) Pub. No.: US 2016/0003094 A1
(43) Pub. Date: Jan. 7, 2016

(54) CMC CORE COWL AND METHOD OF FABRICATING

(71) Applicant: GENERAL ELECTRIC COMPANY, Schenectady,, NY (US)

(72) Inventors: Bernard James RENGGLI, Cincinnati, OH (US); Caroline Elizabeth KEY, Loveland, OH (US); Anthony LAUDE, West Chester, OH (US)

(21) Appl. No.: 14/769,251

(22) PCT Filed: Jul. 30, 2013
(86) PCT No.: PCT/US2013/052630

§ 371 Date: Aug. 20, 2015

Related U.S. Application Data
(60) Provisional application No. 61/677,540, filed on Jul. 31, 2012.

(51) Int. Cl. F01D 25/00; F02K 1/78; F02K 3/06

(52) U.S. Cl. CPC F01D 25/005; F02K 3/06; F02K 1/78; F05D 2300/6033

(57) ABSTRACT

A CMC core cowl for an aircraft gas turbine engine. The ceramic core cowl comprises an interlaced fiber structure having fibers oriented in substantially transverse directions, and a ceramic matrix surrounding the ceramic fiber structure. The core cowl further comprises several panels. The ceramic fiber and matrix are formed into a substantially cylindrical shape extending from a fore end at the fan outlet guide vanes to an aft end at the low pressure turbine outlet guide vanes. The CMC core cowl includes a means for mechanical attachment circumferentially oriented around the fore end and the aft end with mating parts. The CMC core cowl further includes additional plies oriented in a third preselected direction, thereby providing additional strength for mechanical attachment.

### CROSS-REFERENCE TO RELATED APPLICATIONS

This application claims the benefit of prior filed provisional US. Patent Application 61/677,540 filed Jul. 31, 2012.

### FIELD OF THE INVENTION

The present invention is directed to the field of gas turbine engines and specifically to use of ceramic matrix composites for core cowls to reduce weight in aircraft gas turbine engines.

### BACKGROUND OF THE INVENTION

Generally, gas turbine engines operate by burning fuel and extracting energy from the combusted fuel to generate power. Atmospheric air is drawn into the engine from the environment, where it is compressed in multiple stages to significantly higher pressure and higher temperature. The compression is accomplished in the compressor section of the engine. An optional fan section may be located before or in front of the compressor section, that is, fore of the compressor section in certain engines. In addition, the fan section may have multiple stages. A portion of the compressed air is then mixed with fuel and ignited in the combustor to produce high energy combustion gases. The high energy combustion gases then flow through the turbine section of the engine, which includes a plurality of turbine stages, each stage comprising turbine vanes and turbine blades mounted on a rotor. The high energy combustion gases create a harsh environment, causing oxidation, erosion and corrosion of downstream hardware. The turbine blades extract energy from the high energy combustion gases and turn the turbine shaft on which the rotor is mounted. The turbine shaft rotation also results in rotation of the compressor section and the optional fan section, which sections may be directly mounted on the turbine shaft, or more likely, connected to the turbine shaft with gearing and/or auxiliary shafts. The turbine section also may directly generate electricity. A portion of the compressed air is also used to cool components of the turbine engine downstream of the compressor, such as combustor components, turbine components and exhaust components.

Aircraft gas turbine engines are a subclass of gas turbine engines. These engines generally are operated using jet fuel. Furthermore, the exhaust gases passing through the turbine section are used to propel the aircraft. In addition, one of the long sought after goals for aircraft gas turbines is improved operating efficiency, which can be accomplished by weight reduction of the aircraft engine itself and by increasing the temperature capabilities of the turbine itself, so that additional energy can be extracted from the combustion process.

Weight reductions in aircraft turbine engines are a source of improved operating efficiencies. One area of improved operating efficiency is the use of lighter weight materials in the engine. Components of the engine that extend into the hot section have posed not only the greatest opportunities but also the greatest challenges. The opportunities are available because these sections of the engine substantially comprise high temperature-capable metals, such as superalloys, that tend to have a high density as compared to non-metallic materials. The sections of the engine that extend from the cool section of the engine into the hot section furthermore can be relatively large and therefore relatively heavy. However, superalloys are utilized for these hot section components because they have provided the unique combination of mechanical properties at high temperatures as well as corrosion resistance, oxidation resistance and erosion resistance.

Any reduction in weight resulting from substitution of lighter weight material for metallic components is desirable. However, the substitution of materials for an engine component that extends into the hot section must not adversely affect the engineering performance of the component. The component must at least maintain mechanical properties at high temperatures while also providing corrosion resistance, oxidation resistance and erosion resistance.

### BRIEF DESCRIPTION OF THE INVENTION

A ceramic matrix composite (CMC) core cowl for an aircraft gas turbine engine is set forth herein. The CMC core cowl comprises an interlaced ceramic fiber structure having fibers interlaced in substantially transverse directions and a ceramic matrix surrounding the interlaced fiber structure. The ceramic fiber and matrix fabricated into plies are formed into a substantially cylindrical shape having a fore end and an aft end. The core cowl includes a means for mechanical attachment circumferentially oriented around the fore end of the core cowl. The core cowl further comprises a plurality of duct panels, each duct panel attached to an adjacent duct panel along a longitudinal lap joint. The fore end and the lap joints further include additional plies oriented in a third preselected direction, thereby providing additional strength for mechanical attachment.

The CMC core cowl has temperature capabilities in excess of the normal operating temperature of the aircraft gas turbine combustor section and aft of the combustor section, for which core cowl forms a boundary. Because the core cowl is a ceramic matrix composite that is sintered, it is not subject to further oxidation when in use in the turbine engine. The CMC composite has sufficient thickness so that the hot exhaust gases passing over its exterior surface do not result in excessive erosion of the CMC core cowl over the life of the engine.

Other features and advantages of the present invention will be apparent from the following more detailed description of the embodiments, taken in conjunction with the accompanying drawings which illustrate, by way of example, the principles of the invention.

### BRIEF DESCRIPTION OF THE DRAWINGS

FIG. 1 provides a cross-section of a typical high bypass gas turbine engine used in aircraft engine applications.

FIG. 2 is a perspective view of a core cowl showing cowl interface and features.

FIG. 3 (a) is a view of the fore end of core cowl and interface with cowl support bracket, while (b) is a perspective view of core cowl with an assembled access panel.

FIG. 4 is a side view of the core cowl of FIG. 2 depicting two panels and apertures for assembly to core cowl support bracket.

FIG. 5 is a perspective view of FIG. 4 depicting a plurality of duct panels forming core cowl, bifurcation duct and apertures for assembly.

FIG. 6 depicts the penetration in core cowl for assembly of core cowl to cowl support bracket.

FIG. 7 is another view of the assembly of FIG. 6, additionally depicting the assembly of the cowl support bracket to mating engine hardware.

FIG. 8 is a perspective view of a lap joint used to assemble core cowl duct panels together.

### DETAILED DESCRIPTION OF THE INVENTION

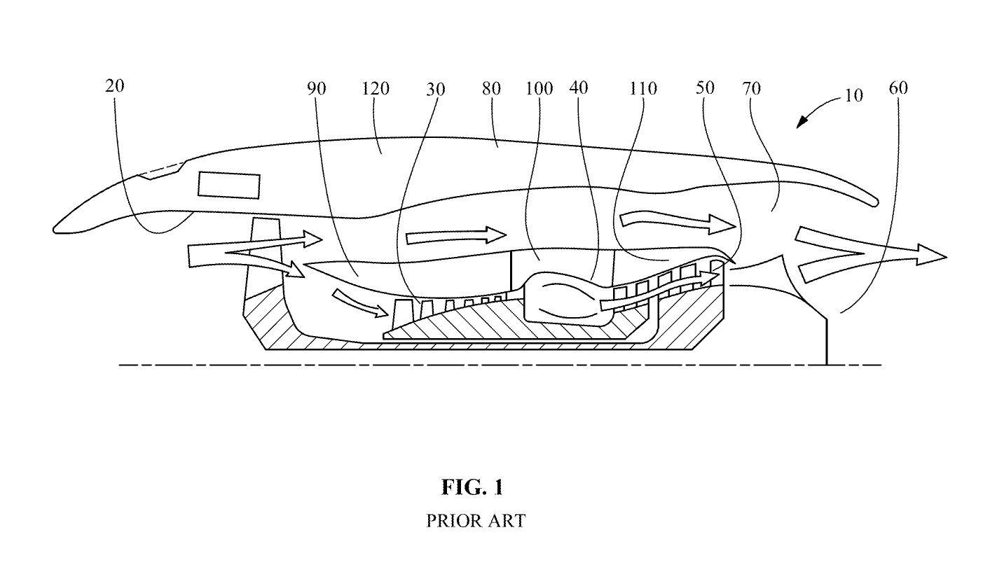

FIG. 1 depicts a partial cross-sectional view of a high bypass gas turbine engine 10. The cross-sectional view displays a fan section 20 in the fore portion of the engine. The fan section 20 may comprise multiple fan stages. Behind or aft of fan section 20 is compressor section 30. Air drawn in through fan section 20 flows into compressor section 30 where it is compressed. A portion of the air drawn through fan section 20 passes around compressor section 30, such air being referred to as bypass air. A substantial portion of compressed air from compressor section 30 enters combustor section 40 where it is used to ignite fuel in a plurality of combustors. A portion of compressed air from compressor section 30 also may be bled and used for active or passive cooling of hot section components, cabin compression, cabin air supply and for other purposes.

Hot gases of combustion passing from combustor section 40 flow through turbine section 50, which may comprise one or more turbine stages. The turbine section 50 extracts energy from the hot gases of combustion to turn fan section 20, compressor section 30 and provide power for auxiliary aircraft functions such as electricity for the cockpit, instrumentation and cabin. Exhaust gases after passing through the turbine section 50 pass over the centerbody and into the exhaust section 60, where the exhaust gases mix with bypass air from fan section 20 to provide thrust to propel the aircraft. Bypass air from the fan passes through a duct 70 formed between core cowl 120, forming first wall of the duct and casings 90, 100, 110 of compressor, combustor and turbine sections respectively, forming an opposed or second wall of duct 70. Duct 70 for flow of bypass air extends from fan section 20 to exhaust section 60. Duct 70 is bounded by core cowl 120 and the wall opposite core cowl, casing 90, 100, 110 respectively extending from the fan outlet guide vane to the low pressure turbine outlet guide vane. While bypass air flowing through duct 70 and over the interior surface of core cowl 120 and exterior surfaces of casing 90 will remain relatively cool, the core cowl may be heated, particularly in its aft portion opposite combustor casing 100 and turbine casing 110 by blackbody radiation as they are heated by combustion and flow of hot combustion gases emanating from these casings and across duct 70.

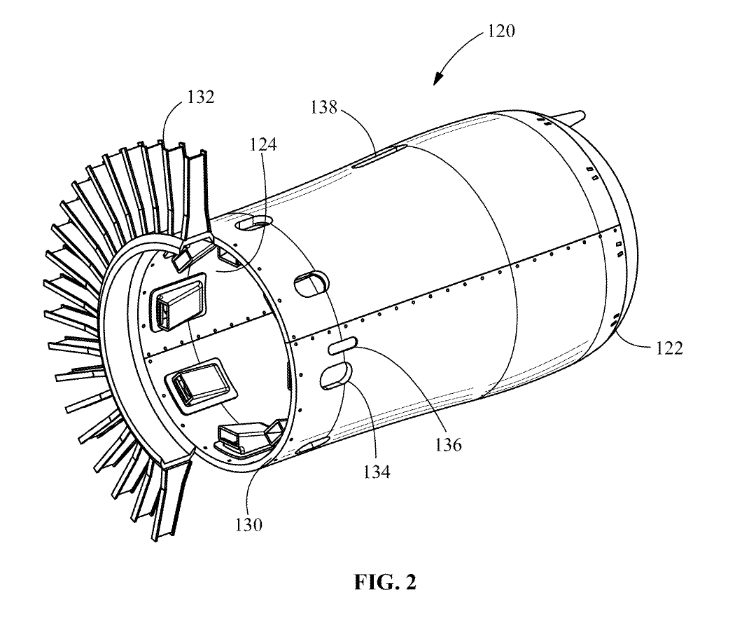

FIG. 2 depicts a perspective view of core cowl 120 of an aircraft engine 10, FIG. 1, and several important interfaces. While bypass air flowing through duct 70 bordered by core cowl 120 will remain relatively cool, a portion of the fan air flows through outlet guide vane and into compressor section 30, combustor section 40 where it is mixed with fuel and ignited, producing combustion gases which are in fluid communication with turbine section 50 before exiting into exhaust section 50 as exhaust gases, an interior surface 124 of core cowl forming a boundary for air by pass flow while casings 90, 100 and 110 form a barrier for air and combustion gas flow through the compressor, combustor and turbine. The temperature that the fluid flowing through duct 70 will vary as the duct boundaries, for which core cowl serves as one barrier and casings 90, 100, 110 serving as the opposite barrier vary greatly, from ambient or close to ambient at the inlet for of fan outlet guide vane, to where casing 90 experiences a temperature about 400-450° F. at the exit of compressor section 30, to where casing 100 experiences a temperature in excess of 2400° F. at the exit of the combustor section 40 to where casing 110 experiences a temperature of about 1800° F. at the exit of turbine section 50 as exhaust gases exit the low pressure turbine and mix with the bypass flow.

In commercial aircraft engines 10, core cowl 120 is comprised of metal or a polymer matrix composite. Core cowl as shown in FIG. 2 is hollow and substantially cylindrically shaped. Because the fast moving hot exhaust gases can cause oxidation and erosion, core cowl is typically a material that resists oxidation, erosion and corrosion. It may be metallic, usually a superalloy, or it may be a polymer matrix composite. When it is a polymer matrix composite (PMC), a heat blanket is provided to thermally insulate the PMC from radiation emanating from casings 100, 110 surrounding the flow paths for hot gases of combustion. As can be seen from FIGS. 1 and 2, the hollow core cowl is a substantially large shaped component, which, either as a metallic component or a PMC component with a thermal insulating blanket, can be heavy. In commercial aircraft, there is little weight difference between a PMC core cowl and a metallic core cowl, as the weight advantages gained by using a PMC material are lost by the inclusion of the thermal insulating blanket.

The present invention utilizes a ceramic matrix composite (CMC) core cowl 120 to reduce the overall core cowl weight without compromising structure integrity or resistance to corrosion, erosion and oxidation. Referring again to FIG. 2, core cowl has an interface with core cowl support bracket 130. Also, fan outlet guide vanes 132 are visible at the fore end of core cowl 120. FIG. 2 also depicts several well known features of a core cowl including variable bleed valve (VBV) ducts/louvers 134, inlet scoops 136 and TBV exhaust 138 which provides bleed air for cooling from the compressor. Each of these features requires a penetration through core cowl 120. Unlike with penetrations in a metallic cowl, which can be provided by simply drilling, penetrations in a CMC cowl require either special lay-up or post drilling repair so that fiber ends are not left exposed and subject to premature environmental attack, erosion or other deterioration, as the exposed interface between the fiber and the matrix provides a path for such attack.

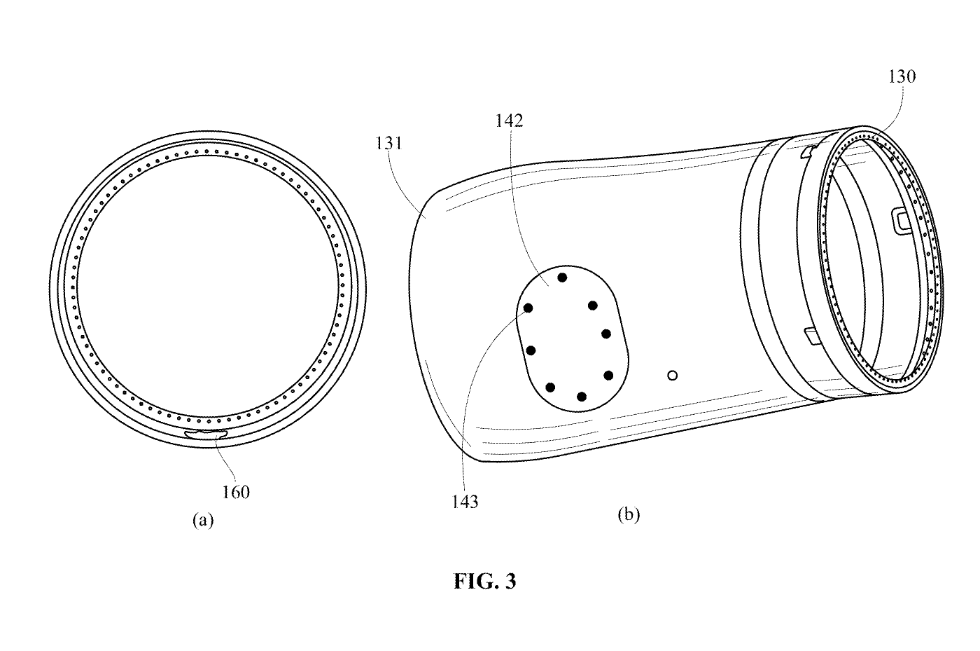

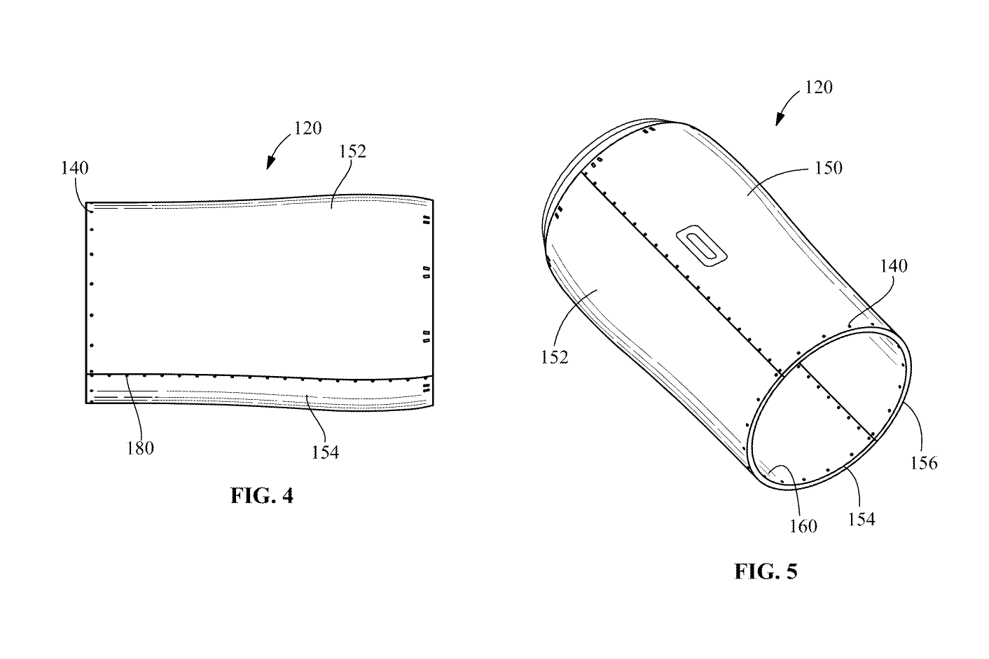

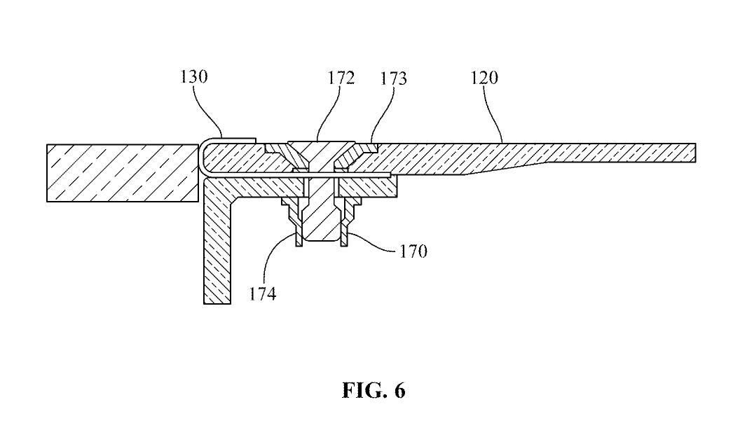

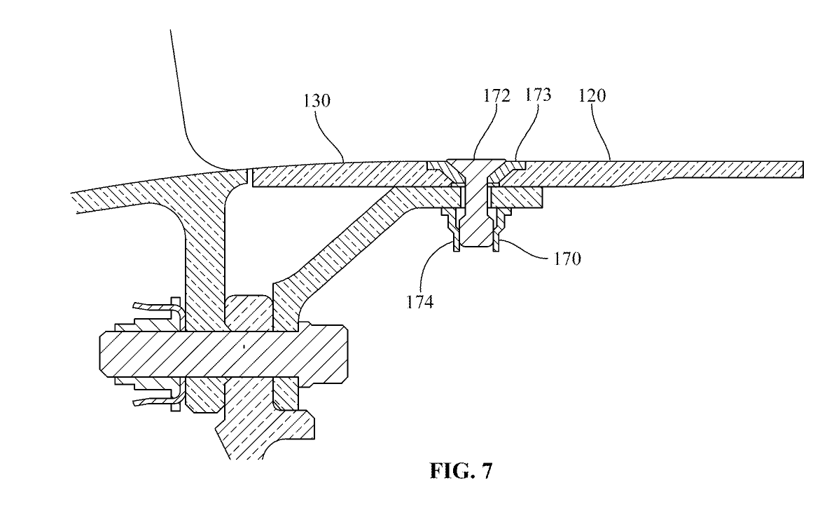

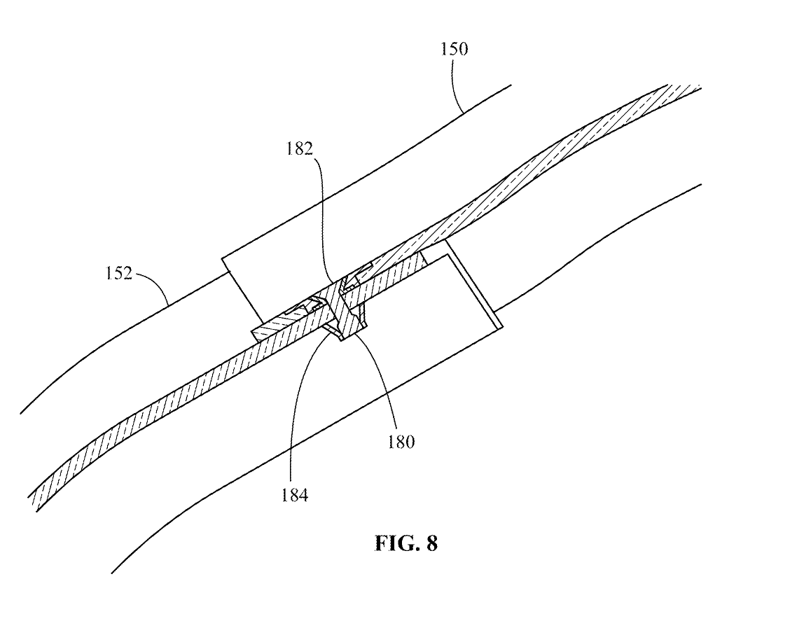

FIG. 3 depicts a view of the fore end of CMC core cowl 120 and its interface with core cowl support bracket 130. A plurality of radially oriented flange penetrations 140 in core cowl 120, FIG. 4, are depicted to permit fit-up of core cowl 120 to support bracket 130. The joint between core cowl 120 and support bracket 130 is depicted more clearly in FIGS. 6 and 7. In an embodiment, the core cowl support bracket 130 is a metallic material, but it is not so limited. Support bracket 130 includes two sets of apertures positioned normal to each other. A first set of radially oriented apertures in support bracket 130 positioned substantially perpendicular to the engine axis coincide with flange penetrations 140 in core cowl when support bracket 130 is assembled to core cowl 120, while a second set of longitudinally oriented apertures in support bracket 130 positioned substantially parallel to the engine axis permit attachment of core cowl 120 to the engine. Core cowl 120 is assembled to support bracket 130 using a plurality of assembly fastener systems 170. While any mechanical assembly fastener system may be used, the plurality of assembly fastener system each includes a threaded male bolt or screw 172 and a mating threaded female nut 174 to secure the overlapping joint. In an embodiment, the female nut 174 comprises the same material as bolt 172. A load spreading insert 173 may be provided between male bolt 172 core cowl for transferring the load uniformly to core cowl 120. Both bolt 172 and insert 173 may be metallic, more particularly aluminum or even lighter weight titanium. In order to provide additional strength in the flange penetration region of the core cowl 120 that includes flange penetrations 140 arranged in a bolt circle, core cowl in an embodiment, includes additional plies lying at a third preselected angle, at a ±45° angle to the other laid up plies in this region, as discussed below, thereby providing additional strength and rigidity to the circumference of core cowl 120 along this bolt circle. Also visible in FIG. 3 is access cover 142 which is removably assembled to a penetration in core cowl 120. Access cover may be a CMC material similar to the CMC comprising core cowl 120, or it may be a metallic material. Clearly, a CMC material provides additional weight savings. Any fastening system may be used to assemble access cover to core cowl 120, although lockable removable access cover screws 143 are included in an embodiment.

FIG. 4 depicts a side view of the core cowl of FIG. 2 partially depicting the construction of core cowl 120. Two panels, a first duct panel 152 and a second duct panel 154 are joined together longitudinally with a second duct fastening system 180. Second duct fastening system 180 may be substantially identical to fastening system 170 and may include a first male threaded bolt 182 and a second female nut 184. If desired, second fastening system may include a somewhat more permanent fastener such as a rivet. The apertures that accept second fastening system 180 extend longitudinally. In order to provide additional strength and rigidity along the longitudinal joint, additional plies lying at preselected angles to the other laid up plies typically laid up transverse to each other, as discussed below, provide additional strength and rigidity to the longitudinal joint joining duct panel 152, 154 of core cowl 120. The additional plies may have fiber oriented at any angle from ±15° to ±75° to the transversely oriented fibers in the plies comprising the panels, although plies in an embodiment have fibers lying at ±45° to the fibers in those plies.

FIG. 5 provides a perspective view of FIG. 4. FIG. 5 clearly shows that core cowl 120 comprises a plurality of longitudinally joined duct panels. In FIG. 5, core cowl 120 comprises four duct panels, first duct panel 150, second duct panel 152, third duct panel 154 and fourth duct panel 156, each duct panel in this arrangement subtending ¼ of the circumference of core cowl 120, or about 90°. The number of duct panels may be more or less. However, for manufacturing and lay-up of the duct panels forming CMC core cowl 120, there are at least two duct panels. Also visible in FIG. 5 is bifurcation opening 160. Bifurcation opening 160 creates a passageway for passage of wires, tubes and other auxiliary hardware. Cooling air generally is provided to this passageway. Bifurcation opening is formed by an appropriate layup of plies to form a duct boundary of ceramic matrix material when cured and sintered. In order to provide additional strength and rigidity along this additional longitudinal joint, additional plies lying at preselected angles, more particularly ±45°, to the other laid up plies are added to the core cowl lay-up, as discussed below, and provide additional strength and rigidity to the longitudinal joint joining duct panel 152, 154 of core cowl 120 along this bolt circle.

FIG. 8 depicts the lap joint utilized to assemble a pair of adjacent core cowl duct panels 150, 152, together along longitudinal joints utilizing fastening system 180. Fastening system 180 is more clearly visible in FIG. 8. The same lap joint arrangement may be used to join the remaining panels 154, 156, to each other and to panels 150, 152 to form core cowl 120.

The present invention utilizes a core cowl 120 comprising a ceramic matrix composite material. Functionally, the ceramic matrix composite material utilized for core cowl 120 must be capable of surviving blackbody radiation for sustained periods of time transmitted from hot core casings (combustor 100 and turbine 110 casings) that are exposed to combustion and exhaust gas temperatures of as high as 2400° F. Active cooling is provided to exterior surface 122 of core cowl 120 by bypass air, which may be bled from duct 70 by inlet scoops 136. Core cowl must also survive erosion due to the flow of bypass gases over its interior surface 124. While the ceramic matrix composite material may be comprised of any combination of ceramic fibers in a ceramic matrix, the materials in an embodiment include polycrystalline α-alumina fibers with silica additions having outstanding creep resistance in an aluminosilicate matrix. However, any other aluminosilicate matrix material may be used. While this describes the material combination in an embodiment, any other combination of ceramic material fibers in a ceramic matrix may be used, such as silicon carbide fibers in a silicon carbide matrix (SiC/SiC composite). An embodiment of the present invention is not restricted to aluminosilicate fibers and aluminosilicate matrices.

The CMC core cowl attaches to a core cowl support bracket 130 at its fore end near the front of the engine. There is little difference in expansion at this joint along the bolt circle because the temperature is ambient or close to ambient.

Core cowl 120 is fabricated by laying up green CMC plies. The plies are formed by dipping the interlaced fiber structure in a slurry of matrix material to form green, pliable ceramic plies and wrapping the plies around a contour mold having a mirror image shape of the each core cowl surface, as is well known in the art. Here, each of the panels may be laid-up separately. Each panel may utilize a different contour mold shape because of different features or apertures, such as an aperture to accept access cover 142. In the fore end of core cowl 120, the circumference that includes flange penetrations 140 along the fore bolt circle at which the mechanical connection joins core cowl 120 to core cowl support bracket is reinforced with additional plies more particularly oriented in the ±45° direction, to provide additional strength around core cowl 120 in the vicinity of this bolt circle. Additional plies to provide additional strength are provided in a similar fashion at other locations where fastening is required, such as along the lap joint joining duct panels and at the location where access cover 142 is removably attached to core cowl 130. Each of these locations may be provided with additional plies, such as plies oriented in the ±45° direction to the laid up plies forming the panels. Because core cowl 120 is not subject to high operating stresses, ply lay-up at other locations is not critical and any acceptable ply lay-up may be used. The only region where there is a concern with stresses is, as discussed, locations of joints. Core cowl 100 must withstand erosion from bypass gases as well as survive the transfer of radiation to the cowl interior surface 124, particularly at its aft end once placed in service.

After the green plies for each duct panel have been applied to the appropriate contour mold for each panel, each green duct panel 150, 152, 154, 156 is cured by heating it to a temperature of about 350° F. for a time sufficient to cure it. Although time will vary with part thickness and curing temperature, and the important functional result is that the duct panel is cured. Curing typically takes about 5 hours at this temperature. Because core cowl 120 varies in thickness along its cross section, it is thin, varying from about 50 mils (0.050 inches) to about 200 mils (0.200 inches), curing may be accomplished as previously noted, the thicker sections generally being determinant of the amount of time required to accomplish curing. Each cured duct panel may then be removed from the contour mold and inspected. At this point, duct panels may be assembled with second fastener system 180 into core cowl 120 and sintered by raising the temperature to at least about 1800° F. In an embodiment however, if desired, each of the duct panels may be sintered prior to assembly.

After sintering, the sintered duct panels may be assembled for form core cowl 120. Since the thermostability of the fibers in an embodiment is about 1200° C. max. (about 2200° F.), the sintering temperature should not exceed this temperature. Although temperatures in the engine may exceed 2200° F., core cowl 120 is cooled by bypass air so that temperatures above 2200° F. are not experienced by core cowl 120, or if experienced, only for short periods of time. The sintering temperature range is about 1800° F. to about 2200° F. Sintering may be accomplished in air for a sufficient time to convert the cured preform duct panels into a ceramic. This may be accomplished by placing assembled core cowl 120 or each of duct panels 150, 152, 154, 156 in a furnace at sintering temperature, or by placing core cowl or each of the duct panels in a furnace and slowly heating or by utilizing quartz lamps to heat to sintering temperature. Any other heating method may be used to sinter the cured ceramic

The CMC composite, after sintering, has a porous matrix structure, which includes fine microporosity, typically having an average size of 0.1 mil (0.0001″) and finer. The porous matrix is an important factor in providing decoupling between the ceramic fibers, more particularly aluminosilicate, and the ceramic matrix, more particularly aluminosilicate. The porous matrix prevents crack propagation across the sintered structure when cracks develop. The porous matrix acts as a crack arrestor while providing adequate strength at the fiber/matrix interface to prevent fiber pullout. Because the CMC is sintered in air at elevated temperature, further oxidation should not occur once core cowl 120 is placed in service.

Following sintering, the sintered core cowl shell may be trimmed by conventional machining methods. Any machined features, such as holes or apertures required to assemble to attachment hardware, may be added by conventional machining operations. The fore end of core cowl 120 in an embodiment includes thin metallic strip or foil 131 to provide the fore end with additional erosion protection. The metal strip may be any erosion-resistant metallic alloy. In an embodiment, the metal strip is titanium or a titanium alloy, due to its light weight, although a stainless steel or a superalloy such as Inconel 718 may also be used. The metal strip has a thickness of about 5-15 mils (0.005-0.015 inches) and extends over the fore outer diameter of core cowl 120 around its fore facing edge to the inner diameter. It may be mechanically fastened or it may be adhered to the core cowl using adhesive or a combination of mechanical attachment and adhesive attachment.

CMC core cowl 120 provides a weight reduction of 20-25% over the prior art PMC core cowls with thermal blankets which is a substantial weight reduction, and the CMC core cowl provides a significant cost reduction over a titanium or titanium alloy structure. The amount of weight reduction will depend upon the size of the engine, larger engines generally having a larger core cowl than smaller engines. CMC core cowl 120 provide an improvement in oxidation resistance, particularly at their aft end, because they are not subject to oxidation as their temperature is increased, as are metallic core cowls, because CMC core cowls 120 in a sintered state are already oxidized. Furthermore, core cowls 120 are suitable for usage even as combustion temperatures are increased and blackbody radiation increases.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A ceramic matrix composite (CMC) core cowl for an aircraft gas turbine engine comprising:
a plurality of duct panels, each duct panel joined to an adjacent duct panel along a longitudinal lap joint, each duct panel further comprising;
an interlaced fiber structure having ceramic fibers oriented in substantially transverse directions;
a ceramic matrix surrounding the ceramic fibers of the ceramic fiber structure;
wherein the ceramic fibers and matrix are formed into a substantially cylindrical shape having a fore end and an aft end, and having a mechanical attachment circumferentially oriented around the fore end and along the longitudinal lap joints; and
wherein the fore end and further includes additional CMC material having fibers oriented in a third preselected direction, thereby providing additional strength to for mechanical attachment at the fore end and at lap joints.

2. The CMC core cowl of claim 1 further comprising:
a bifurcation opening (160) formed by a layup of CMC plies creating a duct boundary
wherein the duct boundary forms a passageway in at least one of the duct panels.

3. The CMC core cowl of claim 1 wherein each of the plurality of duct panels is longitudinally joined to an adjacent core cowl duct panel along an interface.

4. The CMC core cowl of claim 1 further comprising:
a plurality of radially oriented flange penetrations; and
a support bracket having a plurality of radially oriented apertures corresponding to the flange penetrations of the core cowl, the support bracket assembled to a fore end of the CMC core cowl with a mechanical fastening system extending through the flange penetrations and apertures.

5. The mechanical fastening system of claim 4 wherein the mechanical fastening system comprises a rivet through each flange penetration or a plurality of male threaded bolts, one bolt extending through each flange penetration of the core cowl and support bracket aperture, and a plurality of threaded nuts assembled over the threaded bolts.

6. The core cowl of claim 1 further comprising:
a plurality of inlet scoops extending from an interior surface of the core cowl to an exterior surface of core cowl, the inlet scoops providing cooling air to pass from along the interior surface over the exterior surface of the core cowl.

7. The core cowl of claim 1 wherein the ceramic fibers further comprise alumina fibers.

8. The core cowl of claim 1 wherein the ceramic matrix comprises an aluminosilicate.

9. The core cowl of claim 1 wherein the additional CMC material having fibers oriented in a third preselected direction comprises fibers oriented at an angle of ±15° to ±75° to the interlaced fiber structure.

10. A high bypass fan gas turbine engine, comprising:
a fan section;
a compressor section comprising a compressor casing;
a turbine section comprising a turbine casting;
a combustor section comprising a combustor casing, the combustor casing intermediate the compressor casing and the turbine casing;
a CMC core cowl surrounding the compressor casing, combustor casing and the turbine casing;
a bypass duct for flow of air from the fan section and extending between the CMC core cowl and the compressor casing, the combustor casing and the turbine casing;
the CMC core cowl further comprising:
a plurality of duct panels each duct panel joined to an adjacent duct panel along a longitudinal lap joint, each duct panel having
an interlaced fiber structure comprising ceramic fibers oriented in substantially transverse directions,
a ceramic matrix surrounding the ceramic fibers of the ceramic fiber structure,
wherein the ceramic fibers and matrix are formed into a substantially cylindrical shape having a fore end and an aft end, and having a mechanical attachment circumferentially oriented around the fore end and along the longitudinal lap joints, and
wherein the fore end and further comprises additional CMC material having fibers oriented in a third preselected direction, thereby providing additional strength to for mechanical attachment at the fore end and at lap joints.

11. The core cowl of claim 10 further comprising:
a plurality of inlet scoops extending from an interior surface of the core cowl to an exterior surface of core cowl, the inlet scoops providing cooling air flowing in the bypass duct to the exterior surface of the core cowl.

12. The core cowl of claim 10 wherein the ceramic fibers further comprise alumina fibers.

13. The core cowl of claim 10 wherein the ceramic matrix composite comprises alumina fibers in an aluminosilicate matrix.

14. The core cowl of claim 10 wherein the additional CMC material comprises fibers oriented in a third preselected direction includes fibers oriented at an angle of ±15° to ±75° to the interlaced fiber structure.

15. A method for fabricating a CMC core cowl for an aircraft gas turbine engine, comprising the steps of:
providing a plurality of green CMC plies, each ply comprising in interlaced fiber structure in a matrix material;
laying up a plurality of green plies over a contour mold corresponding to a surface of a cowl panel of the core cowl to a thickness of from 50 mils to 200 mils, each contour mold providing a surface corresponding to a lap joint;
curing the cowl panel by heating to a temperature of 350° F. and holding the temperature until the cowl panel is cured throughout its thickness;
assembling the duct panels;
sintering the duct panels by firing in air at a temperature between about 1800°-2200° F.;
machining the sintered panels to provide holes and apertures; then
assembling a support bracket to a fore end of the CMC core cowl.
